(19) United States
(12) Patent Application Publication
(10) Pub. No.: US 2026/0193072 A1
(43) Pub. Date: Jul. 9, 2026

(54) INTERMITTENT PNEUMATIC BUZZER

(71) Applicant: CMO S.R.L., Massa (IT)

(72) Inventor: Andrea PITANTI, Massa (IT)

(73) Assignee: CMO S.R.L., Massa (IT)

(21) Appl. No.: 19/124,006

(22) PCT Filed: Oct. 24, 2023
(86) PCT No.: PCT/IB2023/060716

§ 371 Date: Apr. 24, 2025

(30) Foreign Application Priority Data
Oct. 25, 2022 (IT) 102022000022050

(51) Int. Cl. B66F 17/00; G08B 7/04

(52) U.S. Cl. CPC B66F 17/00; G08B 7/04

(57) ABSTRACT

An acoustic signalling device comprising an oscillator arranged to transform a feed pneumatic flow in an intermittent pneumatic flow. The oscillator comprises an inlet port, arranged to be connected to a pneumatic line to supply the oscillator with the feed pneumatic flow, and an outlet port, arranged to expel the intermittent pneumatic flow. The acoustic signalling device also comprises an acoustic signaller connected to the oscillator by the outlet port, the acoustic signaller arranged to compress the intermittent pneumatic flow for producing an intermittent acoustic signal. The oscillator also comprises an outlet flow regulator arranged to adjust the flowrate of the intermittent pneumatic flow exiting from the outlet port.

### FIELD OF THE INVENTION

The present invention concerns the sector of pneumatically operated acoustic signallers.

In particular, the present invention concerns an intermittent acoustic signaller applicable to a vehicle lift.

### DESCRIPTION OF THE PRIOR ART

As well known, vehicle lifting devices and, more generally, pneumatically powered devices for industrial use often need a signalling device that signals the danger caused by the activation of the machinery or an associated alert state to a certain operation.

However, these devices are widely used in environments where the ATEX directive ( 2014/34/EU) is required which, making it impossible to bring an electrical signal close to the work area, makes it difficult to signal the danger.

Therefore, in this sector there is a need for a pneumatic signalling device with an alternating sound signal which avoids the need for an electrical system near the machinery.

Document CN111188943 describes a pressure pneumatic mechanical alarm device communicating with an air source. The device includes a buzzer, which includes a resonance chamber designed to produce a whistle-like alarm sound.

However, this device, like other similar devices present in the prior art, does not produce an alternating signal, specifically recognizable in work environments as an indication of danger or warning, but rather a continuous signal, used instead as an indication of clearing. Furthermore, this device does not allow the regulation of the incoming pneumatic flow nor does it allow the regulation of the buzzer activation pressure. Therefore, this device is not suitable to operate in the wide working range that can occur during a standard cycle of a pneumatically actuated machine.

In the context of continuous pneumatic sound signals, siren or turbine devices are also present. This type of device, both due to the intensity of the sound signal and the type of sound emitted, cannot however be used to signal the movement of machinery or to signal a danger linked to their use, as they are potentially harmful to the end user, given the frequent intervention of the device during the standard work cycle.

### SUMMARY OF THE INVENTION

It is therefore a feature of the present invention to provide an acoustic signalling device which allows an intermittent acoustic signal to be emitted without the aid of electrical or electronic components.

It is also a feature of the present invention to provide such a device which allows the intensity and frequency of the acoustic signal emitted to be adjusted.

These and other objects are achieved by an acoustic signalling device (100) comprising:
an oscillator arranged to transform a feed pneumatic flow in an intermittent pneumatic flow, said oscillator comprising:
   an inlet port arranged to be connected to a pneumatic line to supply said oscillator with said feed pneumatic flow;
   an outlet port arranged to expel said intermittent pneumatic flow;
an acoustic signaller connected to said oscillator by said outlet port, said acoustic signaller arranged to compress said intermittent pneumatic flow for producing an intermittent acoustic signal;
whose main feature is that said oscillator also comprises an outlet flow regulator arranged to adjust the flowrate of said intermittent pneumatic flow exiting from said outlet port.

Therefore, the acoustic signalling device, according to the present invention, can be connected to the pneumatic line of a pneumatically powered industrial machinery, in such a way as to produce an intermittent acoustic signal which signals the alert state associated with a specific operation of the machinery.

Furthermore, owing to the outlet flow regulator it is possible to mechanically adjust the intensity of the output acoustic signal.

Advantageously, said oscillator also comprises an inlet flow regulator arranged to adjust the flowrate of said feed pneumatic flow entering said inlet port. This way, it is possible to exclude the signalling device from the machinery.

In particular, a calibrated check valve is also provided for allowing said feed pneumatic flow to enter said oscillator only in case that said feed pneumatic flow has a pressure greater than a predetermined threshold. For example, this threshold can be equal to 2 bars.

Advantageously, a visual indicator is also provided arranged to produce a continuous or intermittent visual signal in conjunction with said intermittent acoustic signal.

In particular, said oscillator allows to regulate said intermittent pneumatic flow to vary the intensity and/or frequency of said produced intermittent acoustic signal.

In particular, said inlet port is adapted to be connected to a pneumatic line of a pneumohydraulic pump of a vehicle lift.

Advantageously, said feed pneumatic flow is a continuous pneumatic flow.

According to another aspect of the invention, a system for lifting vehicles off the ground is claimed comprising at least one vehicle lift, connected to a relative pneumohydraulic pump, and at least one acoustic signalling device comprising:
an oscillator arranged to transform a feed pneumatic flow in an intermittent pneumatic flow, said oscillator comprising:
   an inlet port arranged to be connected to a pneumatic line of said pneumohydraulic pump of said vehicle lift to supply said oscillator with said feed pneumatic flow;
   an outlet port arranged to expel said intermittent pneumatic flow;
an acoustic signaller connected to said oscillator by said outlet port, said acoustic signaller arranged to compress said intermittent pneumatic flow for producing an intermittent acoustic signal.

In particular, it is possible to connect two or more acoustic signalling devices to a specific pneumatic machine, in order to have acoustic signals dedicated to different actions of the machinery itself.

In particular, it is possible to differentiate the different acoustic signalling devices connected to the same machinery in frequency and/or intensity of the sound, so as to allow an operator to quickly recognize the different acoustic signals produced and therefore recognize the actions carried out from the machinery itself. For example, it is possible to associate two different acoustic signalling devices with the two directions of movement of a vehicle lift, in order to quickly recognize the direction of movement of the machinery and, therefore, the danger associated with it.

According to a further aspect of the invention, a system for lifting vehicles off the ground is claimed comprising at least one device vehicle lift, connected to a relative pneumohydraulic pump, said pneumohydraulic pump comprising:
a compression chamber;
a piston arranged to carry out a forward stroke and a return stroke in said compression chamber;
an inverter arranged, once ended said forward stroke of said piston, to unload said compression chamber to allow said piston to carry out said return stroke;
said system also comprising an acoustic signaller connected to said compression chamber of said pneumohydraulic pump, said acoustic signaller arranged to compress an intermittent pneumatic flow coming from said compression chamber for producing an intermittent acoustic signal.

In this way, in the event that the pneumohydraulic pump, thanks to the inverter, produces intermittent pneumatic flow, it is possible to connect the acoustic signal directly to the compression chamber to produce an intermittent acoustic signal even without the intermediation of the oscillator.

### BRIEF DESCRIPTION OF THE DRAWINGS

The invention will be now shown with the following description of some exemplary embodiments, exemplifying but not limitative, with reference to the attached drawings in which:

FIG. 1 shows a perspective view of a possible exemplary embodiment of the acoustic signalling device according to the present invention;

FIG. 2 shows a pneumatic diagram of the exemplary embodiment of FIG. 1.

### DESCRIPTION OF SOME PREFERRED EXEMPLARY EMBODIMENTS

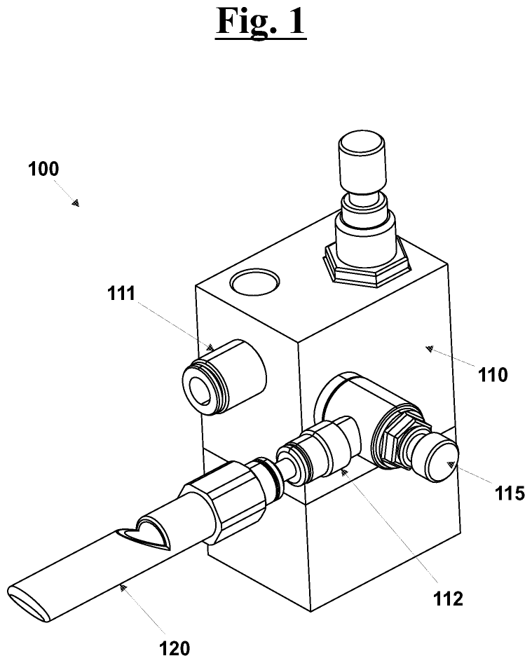

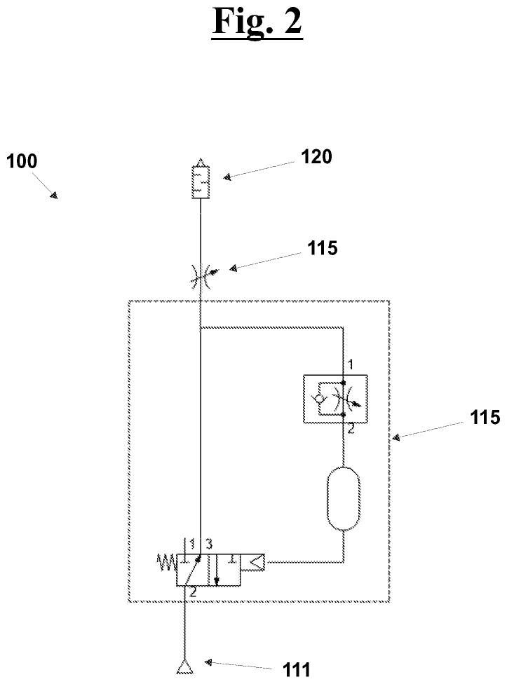

With reference to FIGS. 1 and 2, in a possible exemplary embodiment, the acoustic signalling device 100, according to the present invention, comprises an oscillator 110 arranged to transform a feed pneumatic flow in an intermittent pneumatic flow.

In particular, the oscillator 110 comprises an inlet port 111, arranged to be connected to a pneumatic line to supply the oscillator 110 with the feed pneumatic flow, and an outlet port 112, arranged to expel the intermittent pneumatic flow.

The acoustic signalling device 100 also comprises an acoustic signaller 120 connected to the oscillator 110 by the outlet port 112. In particular, the acoustic Signaller 120 is adapted to compress the intermittent pneumatic flow exiting the oscillator 110 for producing an intermittent acoustic signal.

Therefore, the acoustic signalling device 100, according to the present invention, can be connected to the pneumatic line of a pneumatically powered industrial machinery, in such a way as to produce an intermittent acoustic signal that signals the alert state associated with a specific operation of the machinery. For example, the inlet port 111 may be connected to the pneumohydraulic pump of a vehicle lift or another pneumatic device.

In particular, the oscillator 110 also comprises an outlet flow regulator 115 arranged to adjust the flowrate of the intermittent pneumatic flow exiting the outlet port 112.

Furthermore, the oscillator 110 allows to regulate the intermittent pneumatic flow to vary the intensity and/or frequency of the intermittent acoustic signal product.

Advantageously, the acoustic signalling device 100 can further comprise a calibrated check valve suitable to allow the entry of the feed pneumatic flow in the oscillator 110 only in case that the feed pneumatic flow has a pressure greater than a predetermined threshold. In this way, it is possible to avoid accidental activation of the device 100, and therefore the emission of the acoustic signal.

Furthermore, the oscillator 110 can comprise an inlet flow regulator arranged to adjust the flowrate of the feed pneumatic flow entering the inlet port 111. In this way, it is possible for example to completely exclude the device 100 from the pneumatic circuit or adjust its operation.

Advantageously, it is possible to connect two or more acoustic signalling devices 100 to a specific pneumatic machine, so as to have acoustic signals dedicated to different actions of the machinery itself. In particular, it is possible to differentiate the different acoustic signalling devices 100 in frequency and/or intensity of the sound so as to allow an operator to quickly recognize the different acoustic signals produced and therefore recognize the actions carried out by the machinery. For example, it is possible to associate two different acoustic signalling devices 100 with the two directions of movement of a vehicle lift, in order to quickly recognize the direction of movement of the machinery and, therefore, the danger associated with them.

The foregoing description exemplary embodiments of the invention will so fully reveal the invention according to the conceptual point of view, so that others, by applying current knowledge, will be able to modify and/or adapt for various applications such embodiment without further research and without parting from the invention, and, accordingly, it is therefore to be understood that such adaptations and modifications will have to be considered as equivalent to the specific embodiments. The means and the materials to realise the different functions described herein could have a different nature without, for this reason, departing from the field of the invention. It is to be understood that the phraseology or terminology that is employed herein is for the purpose of description and not of limitation.

1. An acoustic signalling device comprising:
an oscillator arranged to transform a feed pneumatic flow in an intermittent pneumatic flow, said oscillator comprising:
an inlet port arranged to be connected to a pneumatic line to supply said oscillator with said feed pneumatic flow;
an outlet port arranged to expel said intermittent pneumatic flow;
an acoustic signaller connected to said oscillator by said outlet port, said acoustic signaller arranged to compress said intermittent pneumatic flow for producing an intermittent acoustic signal,
wherein said oscillator also comprises an outlet flow regulator arranged to adjust the flowrate of said intermittent pneumatic flow exiting from said outlet port.

2. The acoustic signalling device according to claim 1, wherein said oscillator also comprises an inlet flow regulator arranged to adjust the flowrate of said feed pneumatic flow entering said inlet port.

3. The acoustic signalling device according to claim 1, wherein a calibrated check valve is also provided for allowing said feed pneumatic flow to enter said oscillator only in case that said feed pneumatic flow has a pressure greater than a predetermined threshold.

4. The acoustic signalling device according to claim 1, wherein a visual indicator is also provided arranged to produce a continuous or intermittent visual signal in conjunction with said intermittent acoustic signal.

5. The acoustic signalling device according to claim 1, wherein said oscillator allows to regulate said intermittent pneumatic flow to vary the intensity and/or frequency of said produced intermittent acoustic signal.

6. The acoustic signalling device according to claim 1, wherein said inlet port is adapted to be connected to a pneumatic line of a pneumohydraulic pump of a vehicle lift.

7. The acoustic signalling device according to claim 1, wherein said feed pneumatic flow is a continuous pneumatic flow.

8. A system for lifting vehicles off the ground comprising at least one vehicle lift, connected to a relative pneumohydraulic pump, and at least one acoustic signalling device comprising:
an oscillator arranged to transform a feed pneumatic flow in an intermittent pneumatic flow, said oscillator comprising:
an inlet port arranged to be connected to a pneumatic line of said pneumohydraulic pump of said vehicle lift to supply said oscillator with said feed pneumatic flow;
an outlet port arranged to expel said intermittent pneumatic flow;
an acoustic signaller connected to said oscillator by said outlet port said acoustic signaller arranged to compress said intermittent pneumatic flow for producing an intermittent acoustic signal.

9. A system for lifting vehicles off the ground comprising at least one vehicle lift, connected to a relative pneumohydraulic pump, said pneumohydraulic pump comprising:
a compression chamber;
a piston arranged to carry out a forward stroke and a return stroke in said compression chamber;
an inverter arranged, once ended said forward stroke of said piston, to unload said compression chamber to allow said piston to carry out said return stroke;
said system also comprising an acoustic signaller connected to said compression chamber of said pneumohydraulic pump, said acoustic signaller arranged to compress an intermittent pneumatic flow coming from said compression chamber for producing an intermittent acoustic signal.
